(19) United States
(12) Patent Application Publication
(10) Pub. No.: US 2002/0161692 A1
(43) Pub. Date: Oct. 31, 2002

(54) Method and system for facilitating foreign currency exchange transactions over a network

(76) Inventors: Wing Wah Loh, Singapore (SG); Kim Kok Yap, Singapore (SG)

Correspondence Address: COLUMBIA IP LAW GROUP, PC, 10260 SW GREENBURG ROAD, SUITE 820, PORTLAND, OR, 97223, US

(21) Appl. No.: 09/841,400

(22) Filed: Apr. 23, 2001

(30) Foreign Application Priority Data
Feb. 26, 2001 (SG) 200101113-9

(51) Int. Cl. G06F 17/60

(52) U.S. Cl. 705/37; 705/35

(57) ABSTRACT

A method facilitated by a computer network to accomplish a foreign currency exchange transaction between business entities includes providing a central server system having a communication channel for electronically communicating with the business entities, whereby a representative of a first business entity that is registered is allowed access to the central server system. The representative is then allowed to select a currency pair to be transacted. The system then displays at least one rate for the selected currency pair posted by a representative from a second business entity which is registered with the central server system, the second business entity having established a mutual credit line with the first business entity. Lastly, representative of the first business entity is allowed to place an order on the currency pair, whereby the order is matched against the posted rates, a match resulting in a trade, and a non-match resulting in a posting of the order.

### FIELD OF THE INVENTION

The present invention generally relates to the field of system for facilitating financial transactions, and in particular, to a system for facilitating foreign currency exchange transactions over a network.

### BACKGROUND OF THE INVENTION

Billions of dollars worth of currencies are bought and sold everyday. The buying and selling of currencies, commonly known as foreign exchange (or “forex”), is an activity which is integral to the financial industry. Despite the high volumes, currencies are bought and sold in a manner which is different than many of the other financial products. For instance, stocks are sold in an open market with an open bidding system. Virtually anyone (with some restrictions) can purchase a stock at the posted price so long as a proper protocol is followed and sufficient funding can be shown to exist. In other words, the price of the stock does not depend on the status of the purchaser, and the seller cannot discriminate among the buyers.

Currencies, on the other hand, are not traded on an open market. Traditionally, the forex market has always been a closed system where one institution would trade with another institution whom it considers to be credit worthy. Indeed, an institution always needs to establish a credit line with the institution whom it is trading with before a trade can be executed. The credit line can vary from one institution to another. Obviously, a large institution having a large pool of funds and good credit rating will generally be given a higher credit line than a smaller institution with limited resources. But because the credit line is given by one institution to another and is not established by a central body, an institution can have a different credit line depending on whom it is trading with. For instance, Bank A may have a credit line of one hundred million dollars with Bank B, but may have only eighty million dollars of credit line with Bank C.

Similarly, even the exchange rate one institution charges to another institution may vary depending on the status of the institution. While a number of factors are generally involved in determining an exchange rate, it is not uncommon for an institution to give a more favorable rate to an institution whom it considers to be a better customer.

Because a variety of exchange rates are applied for different institutions and because a credit line must first be established, currencies cannot easily be traded on an open market. Since a credit line is rarely given to any institution without some sufficient level of funding, essentially, forex trading is relegated only to the large institutions with a good credit rating. In addition, since an exchange rate is partially determined by the size of the trade, only trades of sufficient size are made which further limits any small institutions from entering the forex market.

To a large extent, the forex transactions are still conducted in a manual manner. When an institution such as a bank desires to trade currency with another bank, for instance, a trader representing the bank would manually contact a trader representing the other bank. A standard negotiation ensues and an exchange rate is determined by applying a variety of factors such as inter-bank rates, credit worthiness, stability of the currency being traded, etc, all of which are well know those in the forex market.

To automate the trade to some degree, a multitude of forex systems have been developed and are currently being used. One such system is described in the U.S. Pat. Nos. 5,787,402, 5,978,485, and 5,508,913. Other systems can be found on the Internet such as www.forextrading.com while some are proprietary systems available for only a small selected group of banks. One such proprietary system is known as the Electronic Broking System or EBS which generally accepts only the largest of the banks.

Most of the currently available systems relating to forex trading generally fall under two distinct categories. The first type is a system that allows one institution to trade with another institution. Basically, this type of system allows one to enter the particulars of a trade and execute the trade on-line. This type of system is basically one-to-one, that is, one can only submit a forex order to a single financial institution. While the system makes it easier to conduct a trade, all of the necessary protocols such as establishment of credit line, etc., still must be met.

The second type is a system that provides a network of institutions to create a marketplace for forex trading. While a credit line still needs to be established before a trade can be made, once the credit lines have been established, an institution may have access to several exchange rates posted by different institutions. One may think of such a system as a sort of a quasi- open marketplace for currencies. Currently, this system of the second type is available as a proprietary system which limits participation to only a selected group of banks which are typically banks with very large capital.

Although these systems in general do automate many of the conventional manual steps involved in forex trading, they are essentially that: a system for making a conventional forex trading easier. They do not change the fundamental nature of the forex trading itself. For instance, in all of these systems, an entity must still establish a credit line before a trade can b e executed. If a low net worth individual, for instance, wishes to conduct a forex trade, he/she would not be able to do so because no institution would give a credit line to such a person. Same is true for small to medium-sized companies that may need to trade relatively small amounts of currencies. In essence, the current automated systems, while more efficient, is still a closed system.

Yet there are legitimate reasons for smaller institutions and individuals trade currencies. The needs of these players are currently not being met with the existing system (whether it be the traditional manual system or the automated one). While it of course currently possible for the small entities to buy and purchase currencies, they must either purchase them directly from a bank or other financial institutions who will charge a rate which is relatively much higher than those charged in the inter-bank market. This may not b e acceptable, and certainly not optimal, for many of the smaller institutions. Therefore, what is needed is a new way of trading currencies which does not limit the participants to just the large banks or other large institutions while still preserving the basic economic fundamentals of the forex market.

### OBJECT OF THE INVENTION

It is therefore an object of the present invention to provide a method and system for facilitating an exchange of currencies that overcome the shortcomings of the prior art systems described above.

### SUMMARY OF THE INVENTION

The present system has two layers of transaction. The first layer comprises a Web-based foreign exchange (“forex”) market where financial institutions and other business entities can trade currencies. These transactions conducted in the forex market will generally be referred to as B2B (business-to-business) transactions. Although typically these business entities will be banks, present system can accomodate other entities such as corporations, public institutions, and even individuals. To participate in the forex market, there no special software is required; all the business entities need is an internet browser like Internet Explorer or Netscape. The business entities, such as a bank, are able to trade on current credit line structure that currently exists among banks The second layer of the present system facilitates a B2C (business-to-client) transaction, where the business can provide forex trading capability for the business entities' own clients. This B2C feature allows each business entity to take the forex orders from each of their respective clients through the Internet. The system provides online checking of collateral and deposit before accepting the placement of orders. Each business entity can choose to work on the orders they receive from their client by hitting on the clients orders or, strictly at the discretion of each business entity, pass the orders into forex market in the names of the respective business entities (possibly adding a spread first) and using the credit lines of the respective business entities. It is in this way that the business entities' clients are linked up to the forex market. With the ability of straight through processing of clients' orders, business entities can accept clients orders more freely.

The present system includes a central server system 20 system which comprises a Web server engine 22, databases and application managers 24, and a plurality of Web pages 26. The central server system 20 establishes the Web based forex market to facilitate the trading of the currencies among the business entities by providing the necessary interfaces via the Web pages. The central server system is linked via the Internet to a business entity's server system. The business entity's server system comprises a Web server, B2C engine, the PCs of the business entity's various representatives, and the business entity's legacy forex system. The business entity's server system is linked via the Internet to the business entity's client's PCs. The business entity's system, through its Web server and B2C facilitates both the B2B and the B2C transactions. The clients' PCs basically only requires an Internet browser and the appropriate Internet connection.

In one embodiment of the present invention, a method facilitated by a computer network to accomplish a foreign currency exchange transaction between business entities includes providing a central server system having a communication channel for electronically communicating with the business entities, whereby a representative of a first business entity that is registered is allowed access to the central server system. The representative is then allowed to select a currency pair to be transacted. The system then displays at least one rate for the selected currency pair posted by a representative from a second business entity which is registered with the central server system, the second business entity having established a mutual credit line with the first business entity. Lastly, representative of the first business entity is allowed to place an order on the currency pair, whereby the order is matched against the posted rates, a match resulting in a trade, and a non-match resulting in a posting of the order.

In another embodiment, a method facilitated by a computer network to accomplish a foreign currency exchange transaction between business entities includes providing a central server system having a communication channel for electronically communicating with the business entities and registering a first business entity whereby a representative is assigned a role of an administrator, credit officer, and a trader, each role requiring a proper login ID and a password to access the central server system. The trader is then allowed to select a currency pair to be transacted, and the system displays at least one rate for the selected currency pair posted by a trader from a second business entity which is registered with the central server system, the second business entity having established a mutual credit line with the first business entity. Lastly, the trader of the first business entity is allowed to place an order on the currency pair, whereby the order is matched against the posted rates, a match resulting in a fulfillment of the order, and a non-match resulting in a posting of the order.

Yet in another method facilitated by a computer network to accomplish a foreign currency exchange transaction between clients having an account with a business entity includes providing a business entity's system having a communication channel for electronically communicating with the clients and registering the clients with the business entity's system whereby the registered clients are allowed access to the business entity's system and whereby the registered clients place a collateral with the business entity. The clients are then allowed to select a currency pair to be transacted, and the system displays at least one rate for the selected currency pair posted by a registered client. The registered clients are then allowed to place an order on the currency pair, whereby the order is matched against the posted rates, a match resulting in a trade, and a non-match resulting in a posting of the order. The trades are then settled.

### BRIEF DESCRIPTION OF THE DRAWINGS

FIG. 1 is a symbolic diagram illustrating the general concept of the present invention.

FIG. 2 illustrates the physical architecture of the present system.

FIG. 3 illustrates in detail the databases and application managers of the central server system.

FIG. 4 illustrates the components of the B2C engine.

FIG. 5 is a flow diagram illustrating the overall process flow for a business entity to conduct a B2B transaction using the present system.

FIGS. 6 and 6 A are flow diagrams illustrating the process flow for a trader to conduct a trade, step 108 of FIG. 5, using the present system.

FIG. 7 flow diagram illustrating the overall process flow for a client to conduct a B2C transaction using the present system.

FIG. 8 is a Web interface representing a dealing room where a trader conducts foreign exchange trades.

FIG. 9 is a Web interface where credit groups are formed and credit lines are assigned.

FIG. 10 is a Web interface where business entities are placed into a credit group.

FIG. 11 is a Web interface where a client places a foreign exchange order.

FIG. 12 is a Web interface where a trader can view a list of orders placed by clients.

FIG. 13 is a Web interface where a trader can execute a clients order “in house”.

FIG. 14 illustrates the physical architecture for another embodiment of the present invention.

FIG. 15 illustrates in detail the databases and application managers of the business entity's system of FIG. 14.

FIG. 16 is a flow diagram illustrating the overall process flow for conducting a C2C transaction.

FIGS. 17 and 17A are flow diagrams illustrating the process flow for a client to conduct a trade using the system shown in FIG. 14.

FIG. 18 is a Web interface representing a dealing room where a client conducts foreign exchange trades.

### DETAILED DESCRIPTION OF THE INVENTION

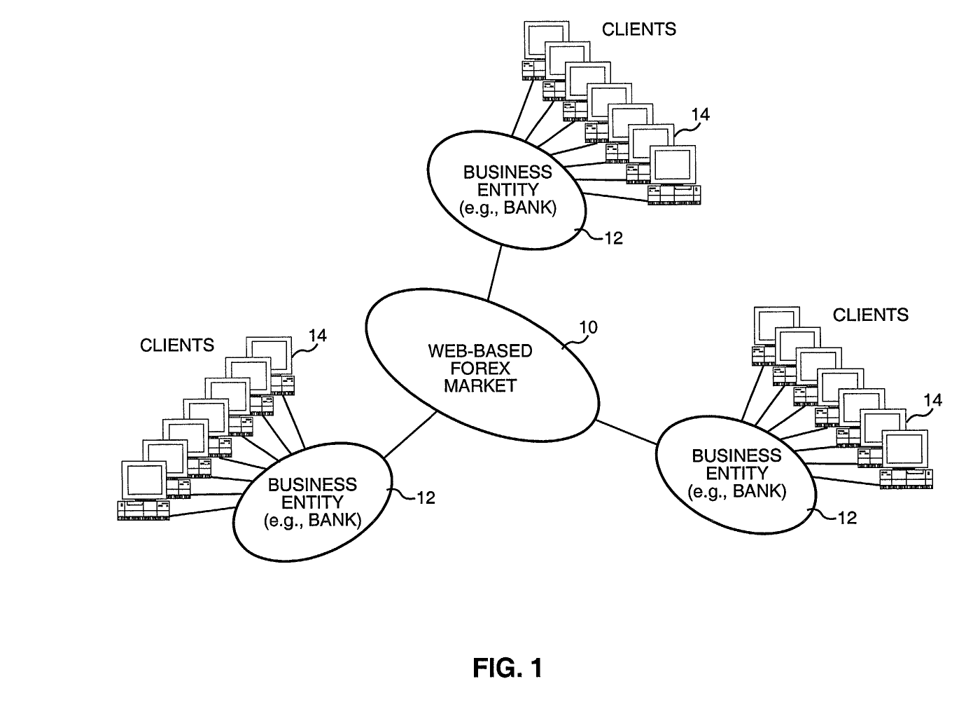

FIG. 1 is a symbolic diagram illustrating the general concept for the present invention. In the preferred embodiment, the present system has two layers of transaction. The first layer comprises a Web-based foreign exchange (“FOREX”) market 10 where financial institutions and other business entities 12 can trade currencies. These transactions conducted in the forex market 10 will generally be referred to as B2B (business-to-business) transactions. Although typically these business entities will be banks, present system can accomodate other entities such as corporations, public institutions, and even individuals. However, because banks will be the most prolific users of the present system, frequent references will be made to banks as an illustrative example. It should be understood, however, that users can encompass a wide range of entities other than just banks.

To participate in the forex market 10, there no special software is required; all the business entities 12 need is an internet browser like Internet Explorer or Netscape. The business entities, such as a bank, are able to trade on current credit line structure that currently exists among banks. In the preferred embodiment, the forex market 10 is available free to these entities 12 on a subscription basis where each participating entity undertakes the legal obligation to settle each trade done on using the present system. The B2B layer can operate independently from the B2C layer of the system.

Still referring to FIG. 1, the second layer of the present system facilitates a B2C (business-to-client) transaction, where the business can provide forex trading capability for the business entity's 12 own clients 14. Most typically, clients will be account holders of a bank, and therefore this business relationship shall frequently be used as an illustrative example, though clearly other scenarios are possible. For instance, the client may also be an employee of a corporation.

This B2C feature allows each business entity to take the forex orders from each of their respective clients through the Internet. The system provides online checking of collateral and deposit before accepting the placement of orders. Each business entity can choose to work on the orders they receive from their client by hitting on the clients orders or, strictly at the discretion of each business entity, pass the orders into forex market 10 in the names of the respective business entities (possibly adding a spread first) and using the credit lines of the respective business entities. It is in this way that the business entities' clients 14 are linked up to the forex market 10. With the ability of straight through processing of clients' orders, business entities can accept clients orders more freely. On the one hand, the present system protects the business entities by giving them the administrative controls like accepting, rejecting, or “transferring” the orders. What spreads being charged to the clients' are entirely the decision of the business entities.

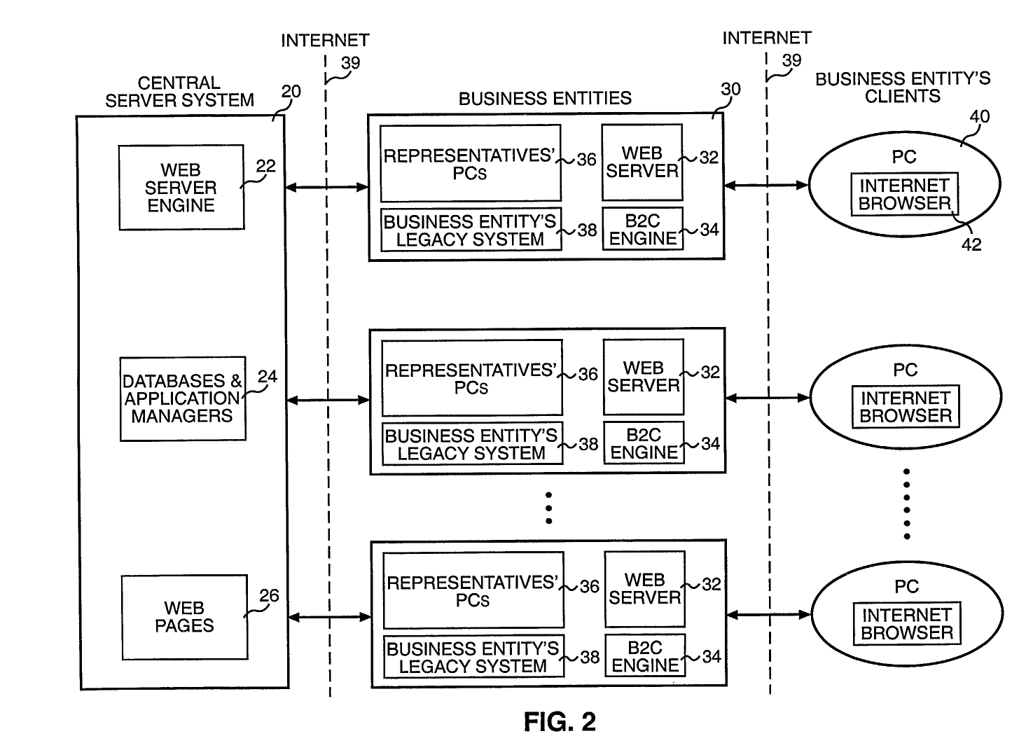

FIG. 2 illustrates the preferred overall architecture of the present financial system. Referring both to FIGS. 1 and 2, the central server system 20 system comprises a Web server engine 22, databases and application managers 24, and a plurality of Web pages 26. The central server system 20 establishes the Web based forex market 10 to facilitate the trading of the currencies among the business entities 12 by providing the necessary interfaces via the Web pages 26. The central server system 20 is linked via the Internet 39 to a business entity's server system 30. The business entity's server system 30 comprises a Web server 32, B2C engine 34, the PCs 36 of the business entity's various 5 representatives, and the business entity's legacy forex system 38. The business entity's server system 30 is linked via the Internet 39 to the business entity's client's PCs 40. The business entity's system 30, through its Web server 32 and B2C 34 facilitates both the B2B and the B2C transactions. The clients' PCs 40 basically only requires an Internet browser 42 and the appropriate Internet connection.

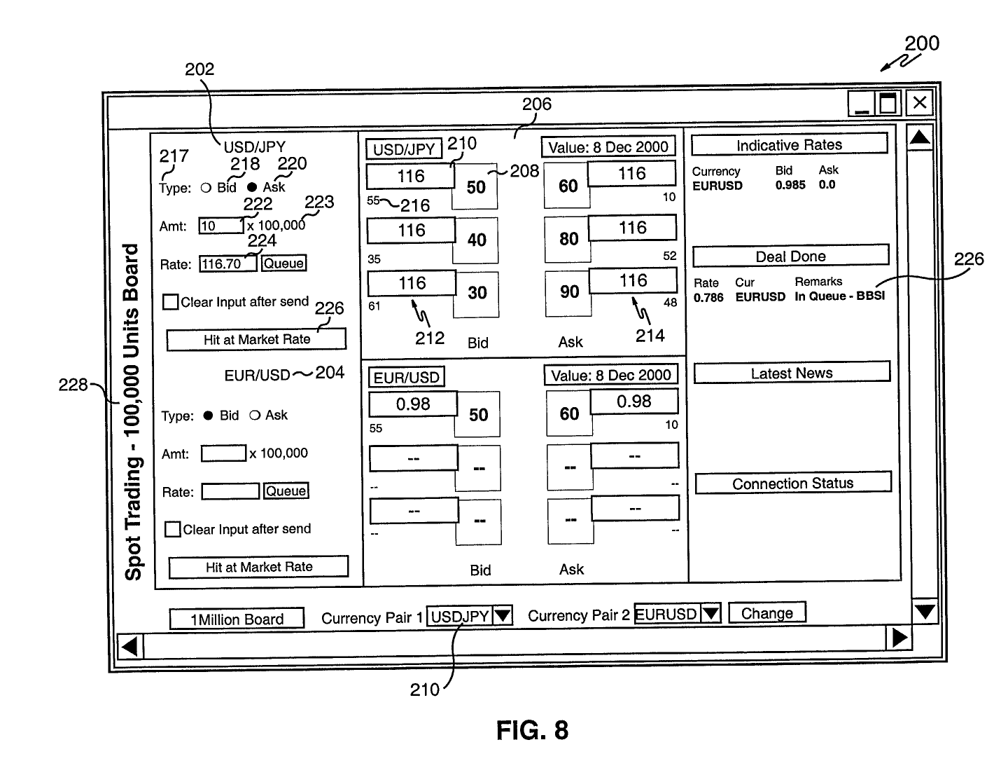

To participate in the forex market 10 using the preferred embodiment of the present system, the business entity's representatives need to be assigned three different roles: a trader, a credit officer, and an administrator. A user representing each role will be assigned a unique login ID and password, and the system will only give access to the interfaces appropriate for the role. The trader's main function is to conduct forex trades on the Web-based B2B dealing room as represented by the interface shown in FIG. 8. The credit officer's main function, among others, is to assign credit limits to parties involved in a trade and to form credit groups. The administrator's main function, among others, is to handle a multitude of administrative duties such as updating user roles, e.g., changing a user from a trader to an administrator, updating trading limit for an individual trader, and defining the preferred settlement method. Each of these representatives can access the central server system 20 via the Internet using a PC from any location. Although generally the PC may be physically located at the business entity's site and may go through the business entity's Web server 32, it should be understood that a PC residing outside of the business entity's system 30 may also be used.

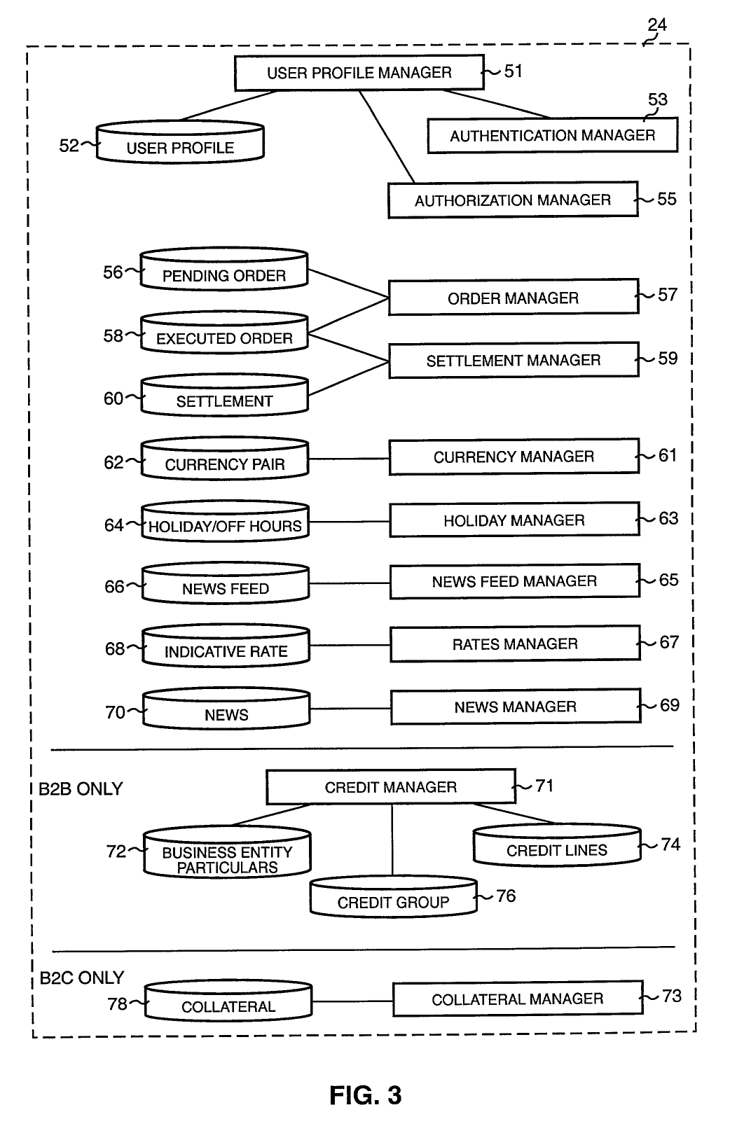

FIG. 3 illustrates in detail the databases and application managers 24. The User Profile Manager 51 facilitates the interfacing between the central server system 24 and the various representatives of the business entities 30 who will be accessing the central server system 24. The user particulars, e.g., user names, login ID, encrypted password, etc., are stored in the User Profile database 52. The Authentication Manager 53 co-operates with the User Profile Manager 51 and User Profile database 52, and authenticates the users by, for instance, matching the user's user ID with a corresponding password. The Authorization Manager 55 co-operates with the User Profile Manager 51 and authorizes the appropriate activities depending on the role assigned for the user. For instance, a user who is designated as a trader would be authorized to trade currencies on behalf of a business entity, but would not be authorized to assign or change credit limits, an activity which is reserved only to a user designated as the credit officer.

The Order Manager 57 handles the administration of the orders (placed by the traders) such as the input and cancellation of the orders. Orders which are placed but not executed (i.e. not traded yet) are stored in the Pending Order database 56. The executed orders are stored in the Executed Order database 58. The Settlement Manager 59 manages the handling of settlement information, e.g., settlement method and settlement account information, and stores the information in the Settlement database 60.

The Currency Manager 61 handles, among others, administration of the currency pairs, the particulars of which are stored in the currency pair database 62. The particulars can include information such as a list of authorized currency pairs, e.g., US$/Yen, currency multiplier, and minimum/maximum trading range.

The Holiday Manager 63 keeps track of holidays and off hours and stores all relevant information in- the Holiday/Off-Hours database 64. The NewsFeed Manager 65 receives news feeds from various sources and stores pertinent information in the news feed database 66 and displays the news on one of the Web pages. The Rates Manager 67 is mainly responsible for the displaying of indicative exchange rates of the various currency pairs which are obtained from public sources. The indicative rates are stored in the Rate database 68. The News Manager 69 handles the display of news relating the present system and the News database 70 stores the news information.

The Credit Manager 71 manages the giving and receiving of credits among the business entities 30 that trade in the forex market 10 provided by the present system. Before a currency can be traded, the business entities must first establish a credit group and provide a credit line to all parties with whom a trade will be made. The information relating to the credit groups is stored in the Credit Group database 76. The credit limits given to the various trading parties are stored in the Credit Limits database 74. The particulars of the business entities such as name, address, etc., are stored in the Business Entity database 72. The Collateral Manager 73 keeps track of the collateral received by the business entity from its clients and stores the information in the Collateral database 78.

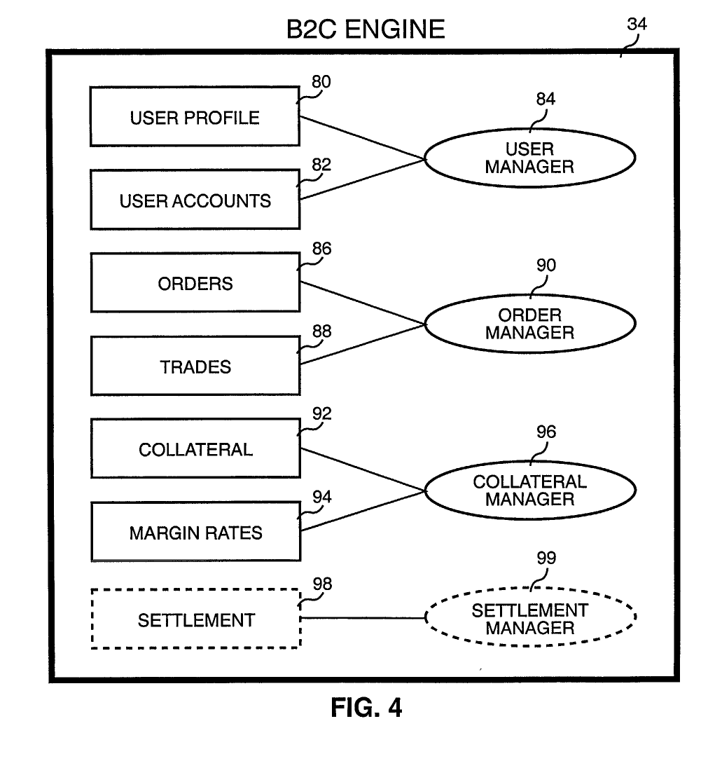

FIG. 4 illustrates the components of the B2C engine 34 of the business entity's system 30. The User Manager 84 facilitates the interfacing between the business entities' system 30 and the clients 40 of the business entities who will be accessing the system 30, including authenticating the users. The user particulars, e.g., user name, address, etc., are stored in the User Accounts database 82. The User Profile database 80, on the other hand, stores user information such as user ID, password, collateral (type and amount), etc.

The Order Manager 90 handles the administration of the orders placed by the clients such as the input and cancellation of the orders. Orders which are placed but not executed (i.e. not traded yet) are stored in the Orders database 86. The executed orders are stored in the Trades database 88. The Collateral database 92 stores the details of the collateral. For instance, the database 92 stores the type and amount of collateral placed by each client and the amount of collateral remaining after assessing the profit and loss of the trades executed by the client. The collateral information is dynamically updated as the client executes a trade.

The Margin Rates database 94 contains three main types of margin rates information. The first type is the spread margin which is the commission the business entity such as a bank charges for each transaction of a currency pair. The second type is the initial margin which is used to calculate the maximum amount a client can trade based on the amount of collateral placed by the client with business entity. The third type is the maintenance margin which is the percentage of the collateral used up by losses in trades before the client needs to top up the collateral. The administration of the collateral and margin rates information is handled by the Collateral Manager 96.

The B2C engine may optionally include a settlement database 98 and a settlement manager 99. Depending on the needs of a particular business entity, the settlement database may simply include information such as settlement method (similar to the central server system's settlement database 60) if the settlement is handled by the business entity's legacy system most commonly found in banks. In the alternative, the settlement database 98 and settlement manager 99 may play a more active role in the settlement process by incorporating all of the account data for each business entity's client.

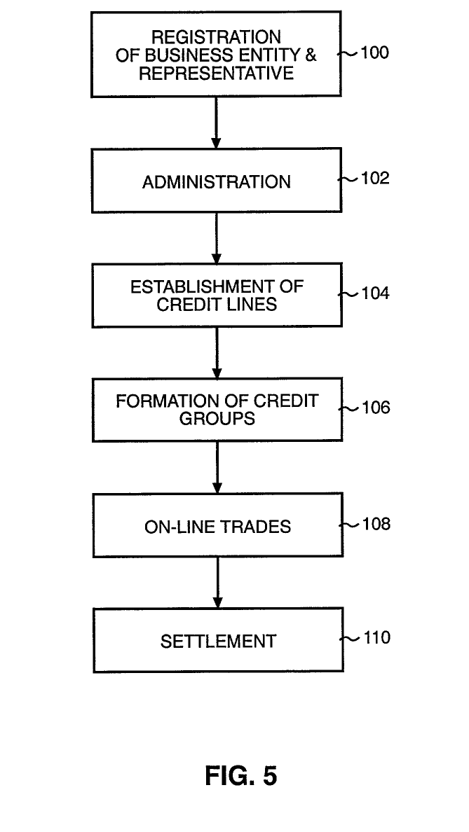

FIG. 5 illustrates the overview process flow for the business-to-business or B2B transaction. In step 100, the business entity that wishes to trade currencies using the present system must first register itself and its representatives with the central server system 20 such that each of the representatives may properly access the system. The representatives must be assigned the roles of administrator, credit officer, and a trader. Once properly registered, in step 102, the administrator performs various administrative activities before a forex order can be placed by a trader. In step 104, the credit officer of a business entity establishes a credit line with one or more other business entities. In step 106, the credit officer accesses the central server system 20 and forms credit groups and allocates a credit line for each group. In step 108, the trader accesses the dealing room and conducts the trades. In step 110, the system settles the executed trades.

The registration of the business entity and its representatives performed in step 100, may be performed on-line or off-line, but it is generally preferred that it be performed off-line to ensure security. The registration process basically entails obtaining the particulars of the registering business entity such as its business name, address, contact person, and in the case where the business is a bank, its dealing code. The business entity also specifies the particulars of the users who will play the role of the administrator, credit officer, and a trader. Of course, it is possible for a single representative to play multiple roles, if need be. Each of the role players will be assigned a unique login ID and a password. Only the user with the proper login ID and password will be able to perform the duties authorized for that particular role. All of the information is stored in the user profile database 52 of FIG. 3. Although in the preferred embodiment multiple roles are defined, it should be understood that it is possible to have a scheme where no formal separation of the roles is made.

The administration duties of step 102 are performed by the administrator. The functions of the administrator are, among other, to update user roles in case there is a change in the role played by a particular user; update trading limit, i.e., a limit to the amount a trader can trade in a given day, for a particular trader; update trading balance, i.e., adjust the balance of the trades made by a particular trader in order to allow a trader to trade beyond the trading limit; update trading time, i.e., the range of time when the trades can b e made by the traders; activate/deactivate a trader's account; create preferred settlement method, e.g., defining which accounts the traded currencies will be drawn from; etc.

In step 104, the business entity such as a bank contacts another business entity, e.g., bank and establishes a mutual credit line with each other. Various means of contact are possible such as communicating over a phone, e-mail, faxes, etc. Although the concept of a credit line is well understood in certain industries such as the banking industry, it should be understood that the term “credit line” as used herein is more general to mean any mechanism or rules of engagement which facilitate an understanding between the trading parties such that an exchange of currency can be accomplished.

Once a credit has been established with one or more business entities, in step 106, by accessing the central server system 20, the credit officer forms credit groups and allocates a credit line to each of the groups. Each credit group represents a single trading entity which may consist of one or more business entities. The credit group allows small institutions to participate in the forex market by aggregating multiple institutions (usually affiliated) so that as a group a sufficient credit line can be established even if as individual entities, sufficient credit line would not be available. For instance, a single banking institutions may have multiple branches in several countries. The branches may decide to trade as a credit group rather than trading individually.

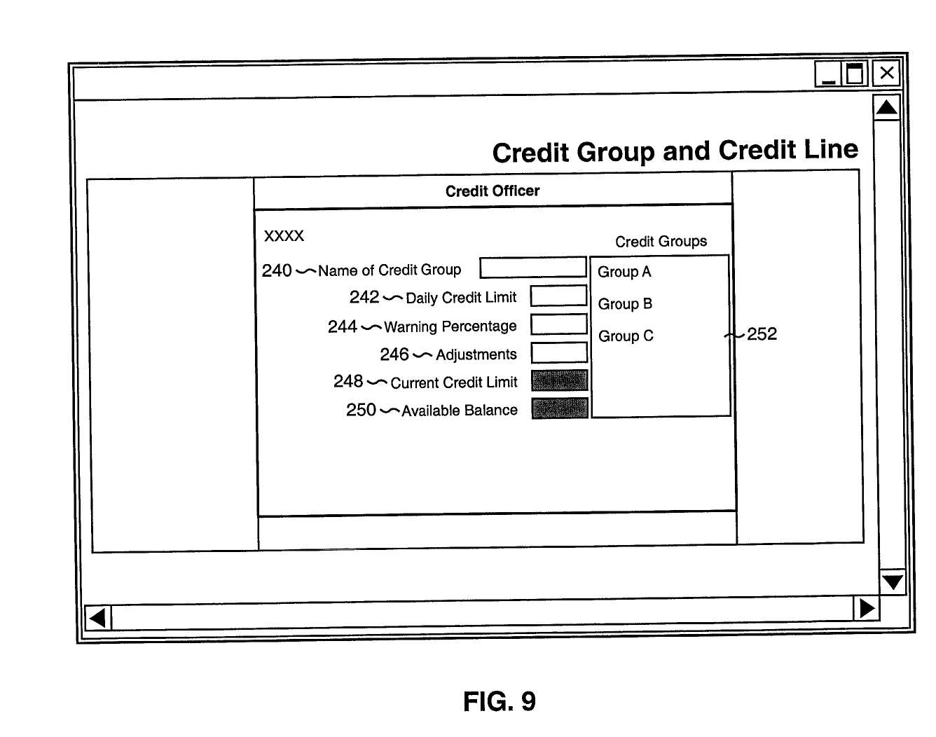

The formation of the credit groups and allocation of credit lines are performed by accessing the interface shown in FIG. 9. The credit officer first enters the name of the credit group 240 in the field provided. Any name is possible. The Daily Credit Limit 242 is then entered which is the daily credit line which was established in step 104 in FIG. 5. The Warning Percentage 244, percentage of credit available before a warning is given, is then entered. If a credit limit has been previously established, it will be shown under Current Credit Limit 248. The Available Balance 250 indicates how much of the credit is remaining. The list of the existing credit groups is shown in a display box 252.

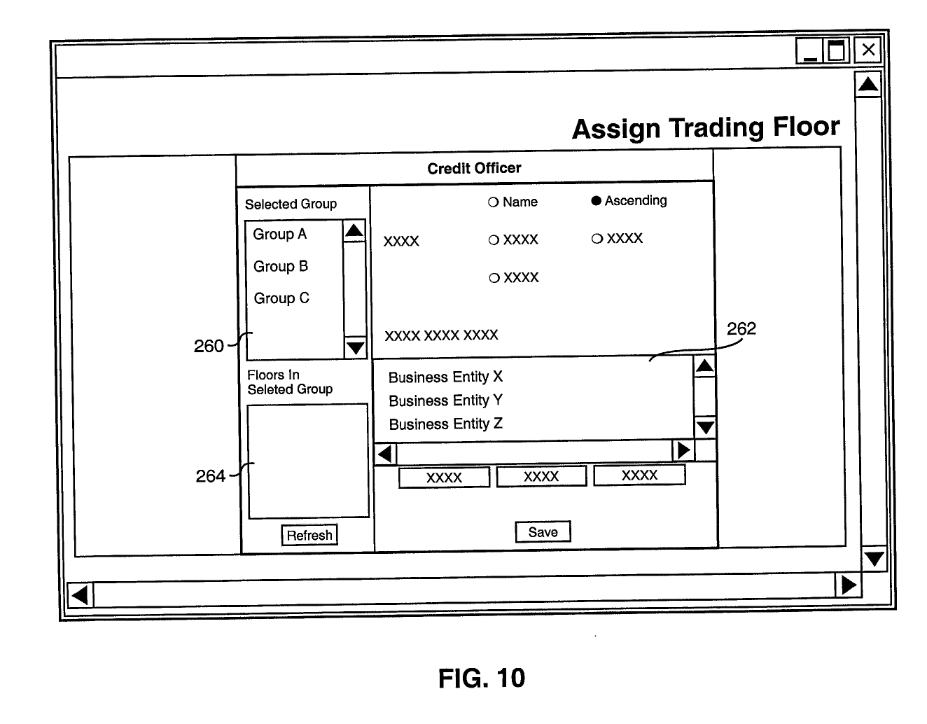

Once the credit groups have been formed and the credit lines have been allocated, the credit officer assigns the trading floors which is a process for assigning the business entities to a credit group. The assignment of trading floor is accomplished via the interface shown in FIG. 10. As shown, the names of the credit groups which were formed using the interface of FIG. 9 are shown in the box 260. In the box 262 is the list of business entities which have been properly registered and which are properly entered into the system 20. The credit officer first selects the credit group in box 260, then selects the names of the business entities from box 262 that it wishes to add to the selected business group. The added business entity is shown in box 264. The process is repeated until all of the business entities listed in box 262 have been assigned to a credit group. Although the formation of a credit group provides the flexibility for business entities to group multiple entities together and thus the feature is highly desirable, it should be understood that the present system may operate without such a feature where each business entity trades under its own name and credit line.

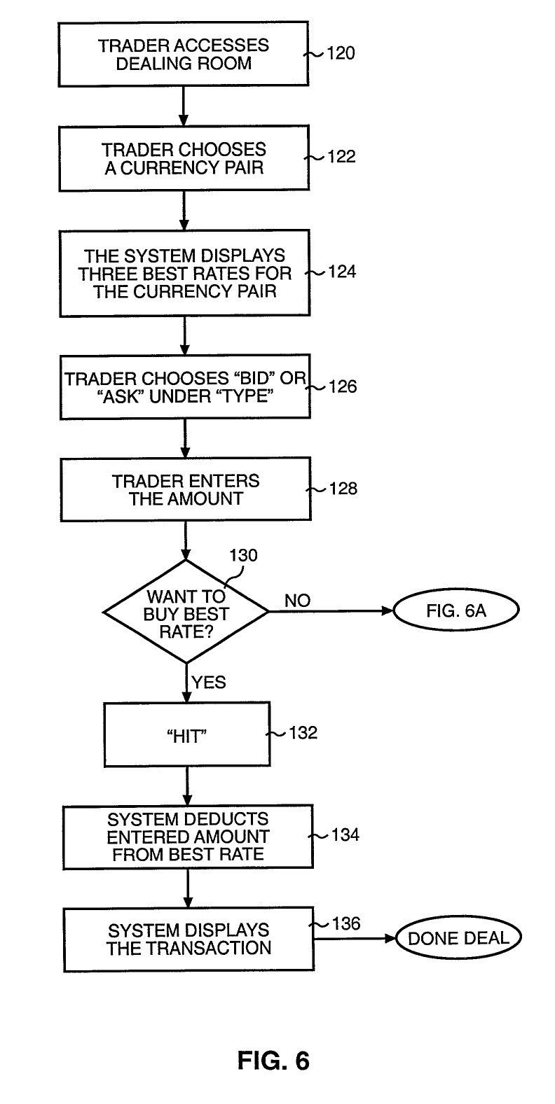

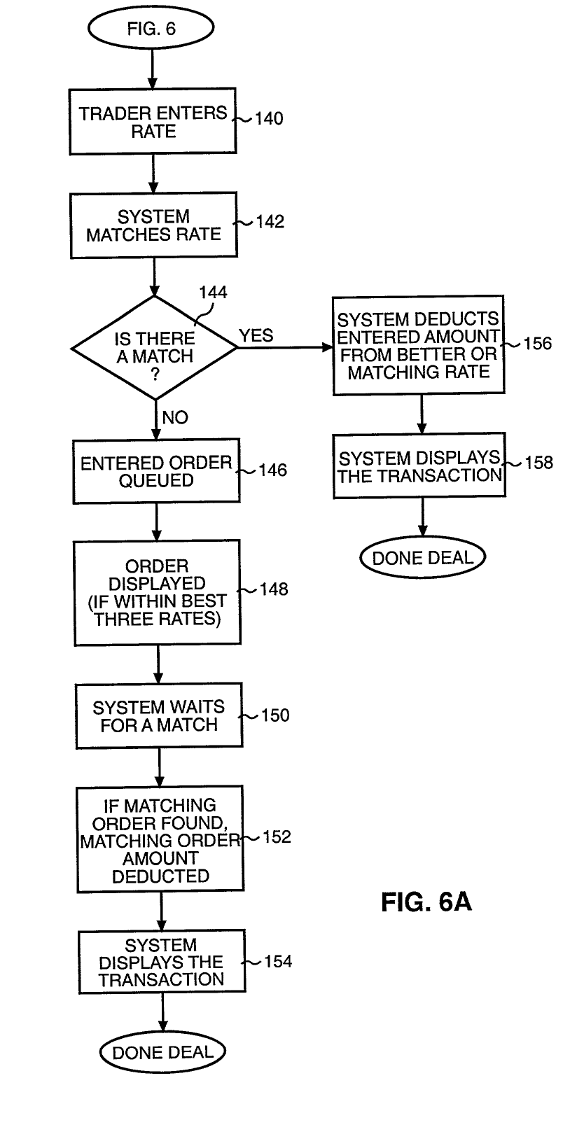

The details of how a trader conduct a trade of currencies using the present system in step 108 shall be explained in reference to the flow diagrams shown in FIGS. 6 and 6 A and the interface 200 shown in FIG. 8. Referring now to FIG. 6, in step 120 the trader accesses the dealing room as represented by the Web interface 200 shown in FIG. 8. The trader then, in step 122, chooses a currency pair from the drop-down menu 210. Note that each interface 200 can show up to two currency pairs, in this case, US dollar against the Japanese Yen (USD/JPY) 202 and European Euro against the U S dollar (EUR/USD) 204. For the purposes of describing the trading process, however, only the USD/JPY will be used as an illustrative example since identical set of steps will apply to all currency pairs.

In step 124, the system displays the best three rates for each currency pair. The rates posted are from those business entities whom the current trader's business entity has established a credit line with and who have been entered into the system. Here, the best three rates for the USD/JPY are listed on the display board 206. Note that the last two digits of the exchange rate are shown in the larger box 208 in bold and the remaining digits are shown in the smaller box 210. The rates on the left side 212 indicate a rate at which the US dollar is being offered to be bought, and therefore the rate most favoring the US dollar will be considered the “best” rate from the viewpoint of the trader looking at the display board 206. The best rate from the viewpoint of the trader is listed first. The rates on the right side 214 indicate a rate at which the US dollar is being offered to be sold, and therefore the rate least favoring the US dollar will be considered the “best” rate from viewpoint of the trader, and will be listed first. The number 216 immediately below the smaller box 210 indicates the number of units of the currency being offered at the rate shown without the multiplier. The multiplier factor 228 is indicated on the left side of the interface. Although here the multiplier is 100,000, other multipliers, e.g., 1,000,000, are clearly possible. Thus here, the number “55” indicates 55×100,000 or US$5,500,000. It should be noted that the amount 55 need not have been placed by a single business entity. Where several business entities place an order for the same rate, the amount is aggregated. Hence the amount 55 may have come from a single business entity, or it may be an aggregation of several orders placed by plurality of business entities. The interface, 200, however does not indicate whether the posted amount comes from a single business entity or is an aggregation of multiple postings.

In step 126, the trader chooses either a “Bid” 218 or “Ask” 220 under “Type” 217. Choosing “Bid” would indicate that the trader wishes to buy US dollar against the Japanese Yen; choosing “Ask” would indicate that the trader wishes to sell US dollar against Japanese Yen. In this case, for illustrative purposes only, “Ask” is selected which indicates that the trader wishes to buy US dollars against the Japanese Yen. In step 128, the trader enters the amount in the amount field 222 that the trader wishes to sell or buy. Note that the multiplier 223 is 100,000, so an entry of 10, for instance, is equaled to 1,000,000 units of currency, and in this case, US dollars.

In step 130, the trader decides whether to buy or sell at the “best” rate posted on the display board 206. If yes, the trader chooses “Hit at Market Rate” 226, step 132, and the system automatically assumes that the trader wishes to trade on the best rate displayed on the display board 206. If the trader has chosen “Bid”, then the “best” rate would be the first rate listed on the right side (“Ask” or “sell” side) of the display board 206. But if the trader has chosen “Ask”, then the “best” rate would be the first rate listed on the left side (“Bid” or “buy” side) of the display board 206. The amount entered in the amount field 222 will then be deducted from the amount 216 shown for the best rate in step 134. Here, because “Ask” was chosen under “Type”, the entered amount “10” will be deducted from the amount “55” 216. If the amount 55 is an aggregation of orders placed by several business entities, the amount 10 will be deducted first from the “Bid” order which was placed first in time. So for instance, if a Business Entity A placed an order for 8 units first and a Business Entity B placed an order for 47 (hence a total of 55) second, then the 8 of the entered amount 10 will be deducted first from Business Entity A's order of 8, and then the remaining 2 units will be deducted from Business Entity B's order of 47. The amount remaining after the deduction, 45, will now be displayed. In the event that the entered amount is larger than what is available on display board, then all of the available amount is deducted from the posting and the remaining amount is posted. Once the deduction is made, the transaction is considered a “done deal” and the system displays the transaction in the “Deal Done” section 226. It should be noted that this section only shows the transactions performed by the current trader; it does not list all of the transactions performed using the system 20.

Now referring to FIG. 6A, if in step 130 of FIG. 6 the trader decides not to take the best rate, then the trader enters the desired rate in the rate field 224 in step 140. In step 142, the system tries to match the rate against posted rates. In this case, the entered rate was 116.70 and the transaction is “Ask” (sell). Therefore, the system 20 looks to the postings on the “Bid” side 212 of the display board 206 to see if there are any buyers who has posted a bid rate which either matches that entered by the trader or is better. Since there is no buyer who is willing to buy US dollars at the rate entered by the trader, the answer to the question in step 144 is “No”, and the system moves to step 146. If, on the other hand, the system determines that there is a match in step 144, then the system deducts the entered amount from the posted rate which either matches or surpasses the entered rate in step 156, and displays the transaction in 158 under section entitled “Deal Done” 226. In step 146, the entered order is queued among other orders. If the order entered is within the three best rates, it is posted on the display board 206 in step 148. The system then waits for a matching order to be placed by traders of other business entities who are using the system in step 150. If a matching order is found, then the system deducts the amount from the posted amount in step 152, and displays the transaction in step 154.

The settlement process of step 110 is performed by the system per the method defined by the administrator. In the preferred embodiment, the settlement process is performed by the business entities off-line using the existing settlement processes.

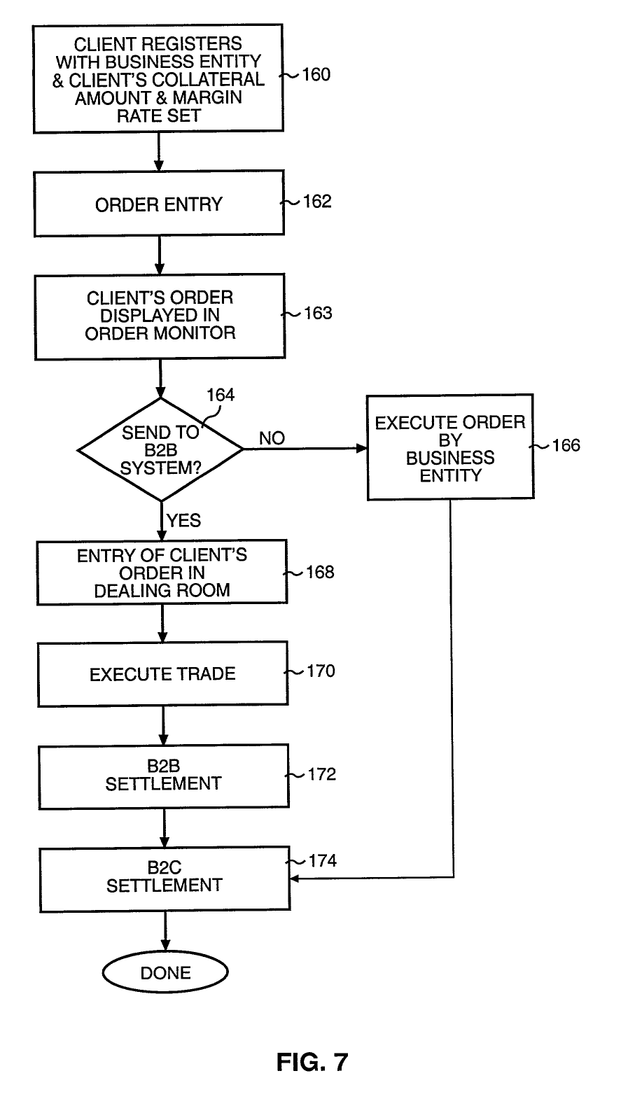

FIG. 7 illustrates the overview process flow for the business-to-client (B2C) transaction. In step 160, the client wishing to conduct a forex trade first registers with the business entity to obtain a login ID and a password. In step 162, the client logs onto the B2C system and places an order. In step 163, the client's order is sent to the order monitor so that a trader can make a decision as to how best to fulfill the order. In step 164, the trader for the business entity decides whether to send the order to the B2B system. If the trader decides to fulfill the order “in-house”, then in step 166, the trader executes the client's order. If, however, the trader decides to fulfill the client's order via the B2B system, then the order is “transferred” to the B2B system and the particulars of the client's order is displayed in the B2B dealing room interface 200 (FIG. 8) in step 168. The trade is then executed in the dealing room in step 170. The business entity then settles the trade with the business entity with whom the trade was made in step 172 (“B2B settlement”). The business entity then settles the trade with the client in step 174 (“B2C settlement”).

The registration of the client performed in step 160, may be performed on-line or off-line, but it is generally preferred that it be performed off-line to ensure security. The registration process basically entails obtaining the particulars of the client such as the name, address, etc. The registration process also entails determining the credit worthiness of the client by obtaining the necessary financial information and conducting a credit analysis of the client. The client also needs to place a collateral with the business entity. Although the collateral will generally be cash, it may be other financial instruments or even goods. For instance, the collateral may be stocks, bonds, or real property.

Based on the amount of collateral placed by the client, and a credit analysis performed on the client by the business entity, the business entity determines the initial margin rate which is used to calculate maximum amount the client can trade. In the preferred embodiment, the maximum amount is calculated using the following formula:

$$\frac{100}{IM} \times C = MaxAmount$$

where

IM=Initial Margin Rate

C=collateral amount in US$.

So for instance, an initial margin rate of 20% with a collateral amount of US$10,000 would sets the maximum amount to be traded at US$50,000. It should be understood that many variations of the above formula are possible depending on the needs of the users, and therefore, the above formula should be taken as illustrative only.

The business entity also sets the maintenance margin rate which is the percentage of the collateral amount which is remaining after offsetting losses in trades before a warning is given to the client to “top up” the collateral. For instance, using the above example where a collateral of US$10,000 was placed by a client, a maintenance margin rate of 5% means that a warning will be given when the total losses reach US$45,000. Once all of the information has been received and the proper financial analysis has been conducted, the client is assigned a login ID and a password which are necessary to make an order entry.

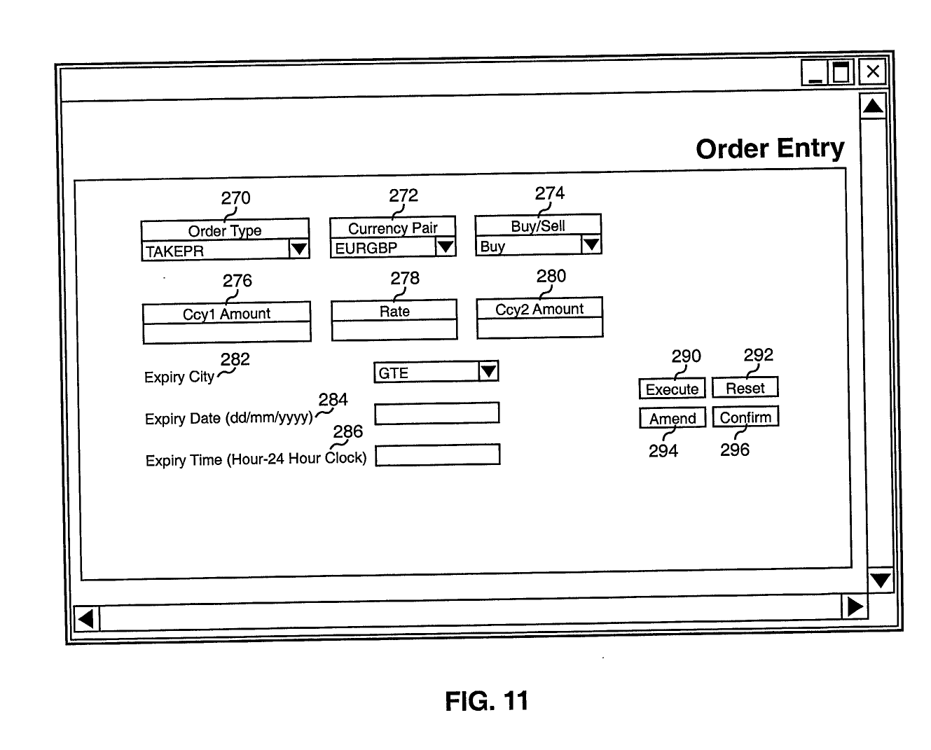

Once a proper login ID and a password are obtained, the client is able to make an order entry The order entry of step 162 of FIG. 7 is performed via the interface shown in FIG. 11. Using the login ID and password, the client first accesses the B2C system via the Internet. The client first chooses the Order Type 270. In the preferred embodiment, the Order Type 270 can be Take Profit, Stop Loss, or Call. Choosing “Take Profit” means that the client's order is executed when the entered rate is met or exceeded. “Stop Loss”, on the other hand, is the price level at which further losses are limited by the act of terminating an open position when the stop loss limit is reached. Choosing “Call” means that the trader needs to call the client for confirmation before a trade on the client's order is executed.

After making a selection under Order Type 270, the client chooses the currency pair 272, e.g., US$Yen. The client chooses whether to sell or buy a currency under Buy/Sell 274. If US$Yen was selected as the currency pair, for instance, choosing “Buy” would indicate that the client wishes to purchase US$ against the Yen; choosing “Sell” would indicate that the client wishes to sell US$ against the Yen. The client then enters the Currency 1 Amount 276, or the currency listed first in the currency pair. For example, if the currency pair US$/Yen was chosen, the “first” currency would be the US$. Once the amount Currency 1 Amount 276 is entered, the Currency 2 Amount 280 is automatically calculated. The client next enters the Rate 278 at which the client wishes to buy or sell the currency. Some of the other particulars submitted the client are Expiry City 282 (time zone where the client is located for time zone determination purposes), Expiry Date 284 (the date when the order is to expire), and Expiry Time 286 (the time when the order is to expire).

Once all of the information is entered, the client hits “Execute” 290. This prompts the system to check to see if all of entered data is valid and calculates currency amount (either 276 or 280) for the currency pair using the entered rate 278, and also calculates the expiry date of the order taking into account any time zone differences. The calculated values are then displayed in the corresponding fields. After observing the calculated numbers, the client can choose to amend the entered data by hitting Amend 292. If the client is satisfied with the order, then he may hit Confirm 296 which sends the order to the Order Monitor (explained below). Hitting the Reset 292 clears all of the fields and returns them to default values, but this option is only available before the order is executed.

When the client's order is sent to the Order Monitor in step 163, the order can be viewed by a trader through a B2C desktop application which can reside on a business entity's trader's PC. Using this application, the trader can perform various functions such as view the clients' orders, execute the orders, cancel or assign the orders, etc. provided that the trader has properly been assigned a login ID and a password which are needed to access the B2C desktop application.

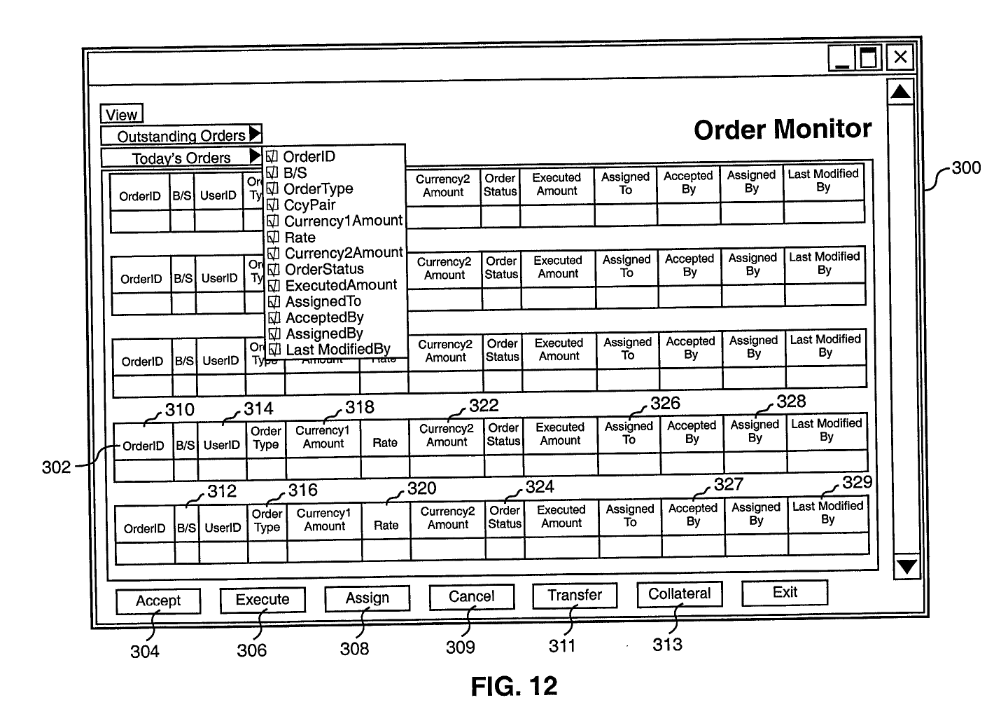

The client's orders which have been confirmed are displayed on an Order Monitor display. FIG. 12 illustrates the Order Monitor display 300 showing a list of the outstanding orders 302 which are orders which are unexecuted or partially executed. For each order, the Order Monitor 300 displays the following (corresponding part numbers in parenthesis):

| | |
|---|---|
| Order ID (310): | a unique identifier for the order |
| B/S (312): | Buy/Sell |
| User ID(314): | a unique identifier for the client placing |
| | the order |
| CcyPair(316): | currency pair |
| Currency 1 Amount(318): | Amount of the first currency |
| Rate(320): | exchange rate for the currency pair |
| Currency 2 Amount(322) | Amount of the second currency |
| Order Status(324): | Status of the order, e.g., partially executed |
| Executed Amount(326): | Amount of order executed |
| Assigned To(328): | Name of trader to whom the order is |
| | assigned |
| Accepted By(330): | Name of trader accepting the order |
| Assigned By(332): | Name of trader assigning the order |
| Last Modified By(334): | Name of trader last modifying the order |

When an order is first received, the trader must first “Accept” the order by highlighting the order and pressing the “Accept” button 304 to indicate that the trader is accepting the order. If, however, the trader does not wish to accept the order, he may “assign” the order by highlighting the order and pressing the “Assign” button 308. Moreover, the order may also be canceled by highlighting the order and pressing the “cancel” button. Pressing on the “collateral” button allows the trader to see the client's collateral information.

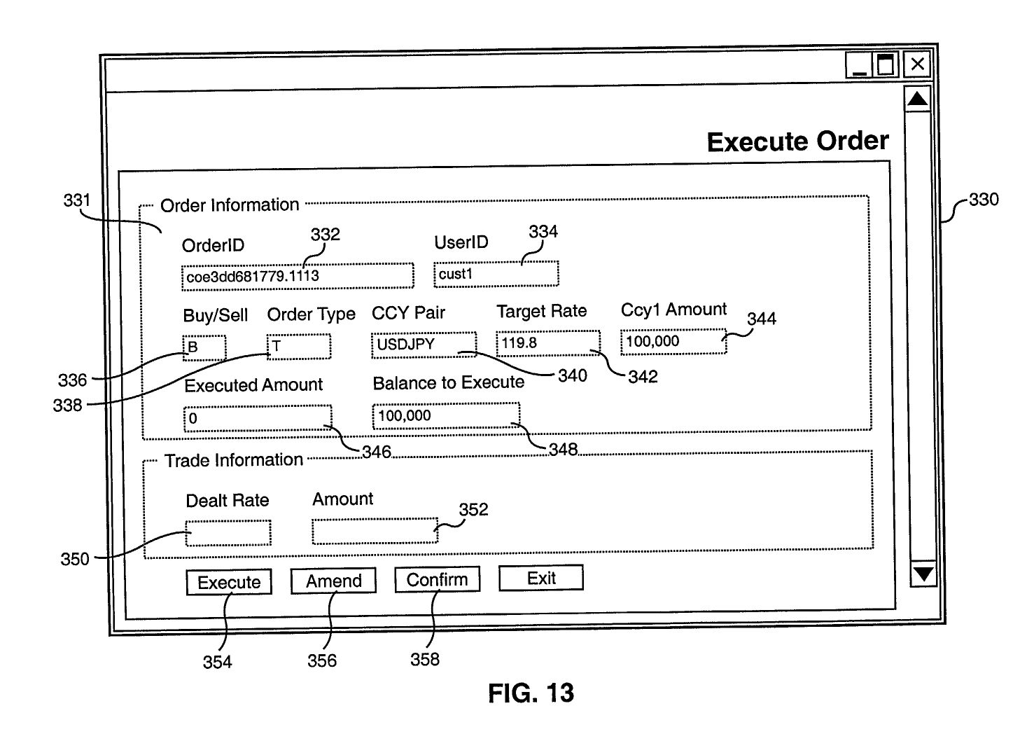

The critical decision the trader must make in step 164 (FIG. 7), is whether to “transfer” the order to the B2B system or to execute the order “in house”, i.e., execute the order by the business entity. To execute an order per step 166, the trader highlights an order and presses the “Execute” button 306 at which time the Execute Order interface 330 of FIG. 13 appears. All of the relevant particulars of the highlighted order are imported into the relevant fields of the Execute Order interface 330 under Order Information 331. In particular, the imported information is the following: Order ID 332, User ID 334, Buy/Sell 336, Order Type 338, Ccy Pair 340, Target Rate 342, Ccyl Amount 344. The Balance To Execute 348 is calculated by subtracting the Executed Amount 346 from the Ccl Amount 344.

Based on the Order Information 331 given, the trader enters the Dealt Rate 350 and Amount 352. The trader may choose to enter the entire amount of the Balance to Execute 348, or choose to only partially execute the order by entering an amount which is less than the Balance to Execute 348. The trader executes the order by pressing the “Execute” button 354 which freezes all of the data in the fields which can be amended only by pressing the “Amend” button 356. Once everything is confirmed, the trader presses the “Confirm” button 358. Once the order has been properly fulfilled, the business entity settles the trade with the client in step 174.

If, in step 164, the trader decides to transfer an order to the B2B system, the trader highlights the order on the Order Monitor 300 and presses the “transfer” button 311. The selected order is then sent to the B2B dealing room 200 of FIG. 8 and particulars of the order are entered into the appropriate fields in a manner similar to how a trader would enter the data using the same interface 200. The order is then executed per the usual B2B trading process where the clients order has essentially been “white labeled” by the business entity. In other words, the other business entities using the B2B system is unaware that the order has originated from a business entity's client. Once the trade has been executed in step 170, the trade is first settled at the B2B stage, and then subsequently settled at the B2C stage with the business entity's client.

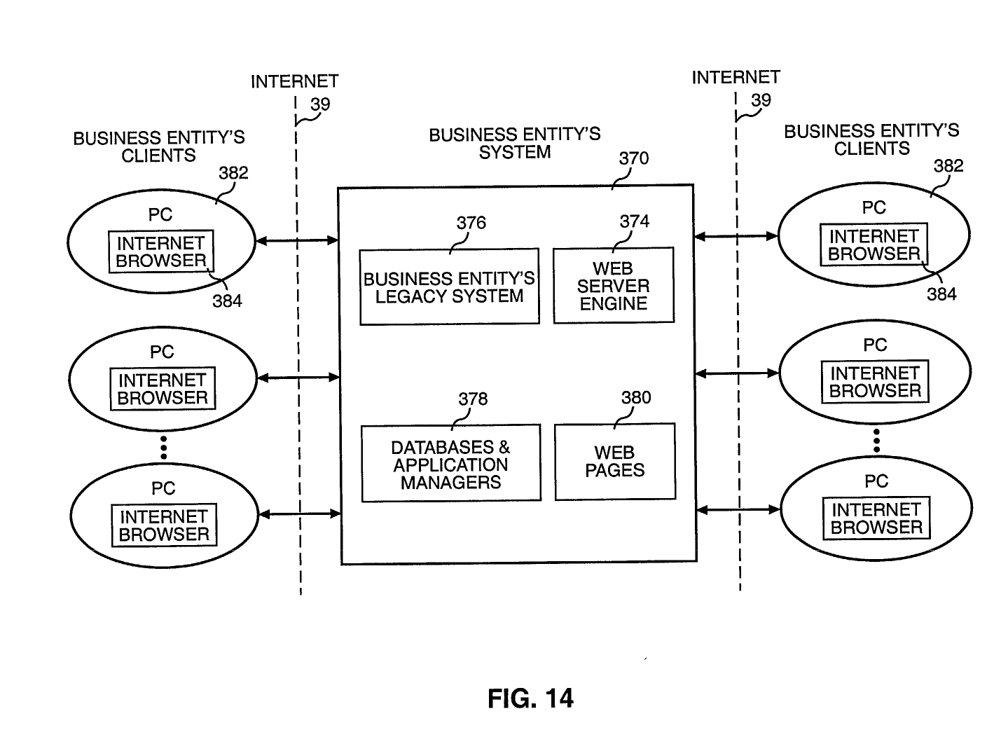

FIG. 14 illustrates an another embodiment of the present invention where the business entity essentially plays the role of the Central Server System 20 (FIG. 2) and allows its clients 382 to trade currencies amongst each other in a manner which is substantially similar to the B2B system described above. This type of transaction is called the client-to-client, or C2C, transaction. The embodiment of FIG. 14 includes a business entity system 370 which is accessible via the Internet by the business entity's clients PCs 382 having an Internet browser 384. The business entity's system 370 includes a Web server engine 374, business entity's legacy system 376, databases and application managers 378, and Web pages 380.

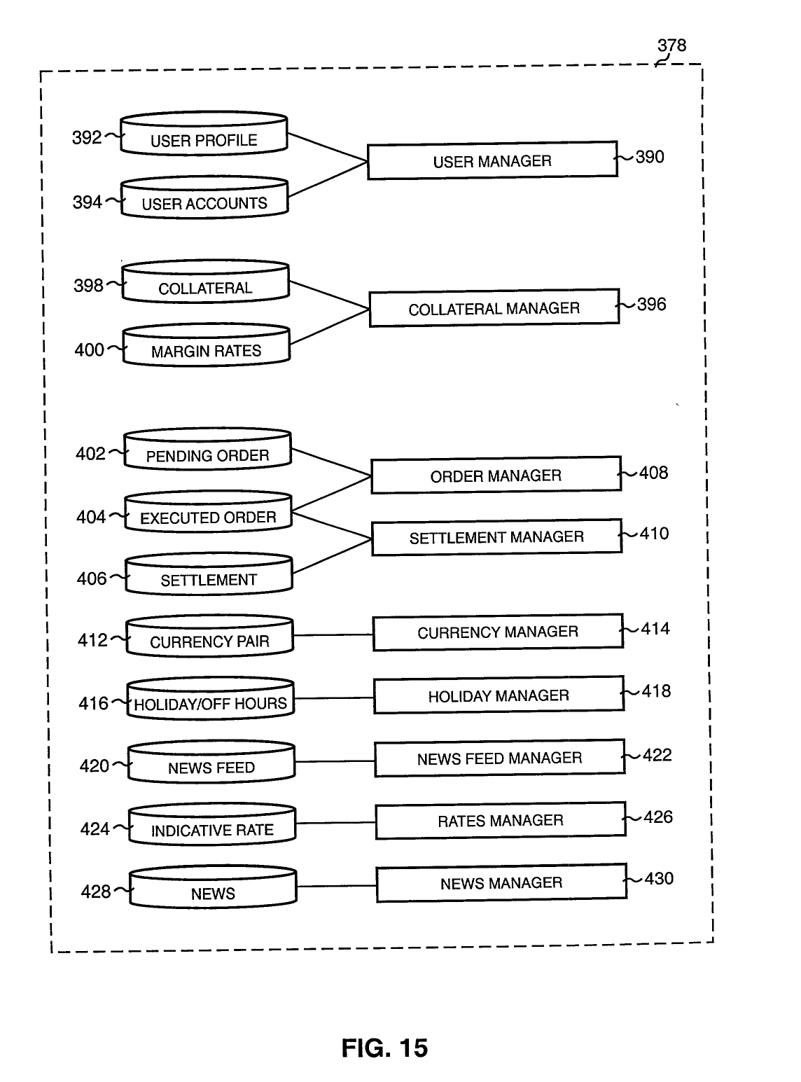

FIG. 15 illustrates the databases and application managers 378 in detail. The User Manager 390 facilitates the interfacing between the business entity's system 370 and the clients 382 of the business entity who will be accessing the system 370. The user particulars, e.g., user name, address, etc., are stored in the User Accounts database 394. The User Profile database 392, on the other hand, stores user information such as user ID, password, collateral (type and amount), etc.

The collateral database 398 stores the details of the collateral. For instance, the database 398 stores the type and amount of collateral placed by each client and amount of collateral remaining after assessing the profit and loss of the trades executed by the client. The collateral information is dynamically updated as the client executes a trade.

The Margin Rates database 400 contains three main types of margin rates information. The first type is the spread margin which is the commission the business entity such as a bank charges for each transaction of a currency pair. The second type is the initial margin which is used to calculate the maximum amount a client can trade based on the amount collateral placed by the client with business entity. The third type is the maintenance margin which is the percentage of the collateral used up by losses in trades before the client needs to top up the collateral. The administration of the collateral and margin rates information is handled by the collateral manager 396.

The Order Manager 408 handles the administration of the orders such as the input and cancellation of the orders. Orders which are placed but not executed (i.e. not traded yet) are stored in the Pending Order database 402. The executed orders are stored in the Executed Order database 404. The Settlement Manager 410 manages the handling of settlement information, e.g., settlement method and settlement account information, and stores the information in the Settlement database 406.

The Currency Manager 414 handles, among others, administration of the currency pairs, the particulars of which are stored in the currency pair database 412. The particulars can include information such as a list of authorized currency pairs, e.g., US$Yen, currency multiplier, and minimum/maximum trading range. The Holiday Manager keeps track of holidays and off hours and stores all relevant information in the Holiday/Off-Hours database 416. The News Feed Manager 422 receives news feeds from various sources and stores pertinent information in the news feed database 420 and displays the news on one of the Web pages. The Rates Manager 426 is mainly responsible for the displaying of indicative exchange rates of the various currency pairs which are obtained from public sources. The indicative rates are stored in the Indicative Rate database 424. The News Manager 430 handles the display of news relating the present system and the News database 428 stores the news information.

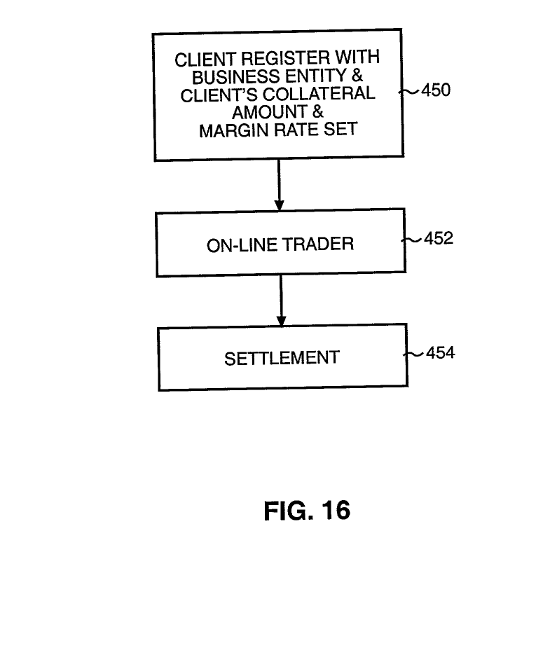

FIG. 16 illustrates the overview process flow for the client-to-client or C2C transaction. In step 450, the client wishing to conduct a forex trade first registers with the business entity to obtain a login ID and a password. In step 452 the client logs into the business entity's system via the Web pages 380 and trades on-line. In step 454, the executed trades are settled.

The registration of the client performed in step 450, may be performed on-line or off-line, but it is generally preferred that it be performed off-line to ensure security. The registration process basically entails obtaining the particulars of the client such as the name, address, etc. The registration process also entails determining the credit worthiness of the client by obtaining the necessary financial information and conducting a credit analysis of the client. The client also needs to place a collateral with the business entity. Although the collateral will generally be cash, it may be other financial instruments or even goods. For instance, the collateral may be stocks, bonds, or real property. Based on the amount of collateral placed by the client, and a credit analysis performed on the client by the business entity, the business determines the initial margin rate which is used to calculate maximum amount the client can trade. In the preferred embodiment, the maximum amount is calculated using the following formula:

$$\frac{100}{IM} \times C = MaxAmount$$

where

IM=Initial Margin Rate

C=collateral amount in US$.

So for instance, an initial margin rate of 20% with a collateral amount of US$10,000 would sets the maximum amount to be traded at US$50,000. It should be understood that many variations of the above formula are possible depending on the needs of the users, and therefore, the above formula should be taken as illustrative only.

The business also sets the maintenance margin rate which is the percentage of the collateral amount which is remaining after offsetting losses in trades before a warning is given to the client to “top up” the collateral. For instance, using the above example where a collateral of US$10,000 was placed by a client, a maintenance margin rate of 5% means that a warning will be given when the total losses reach US$45,000. Once all of the information has been received and the proper financial analysis has been conducted, the client is assigned a login ID and a password which are necessary to make an order entry.

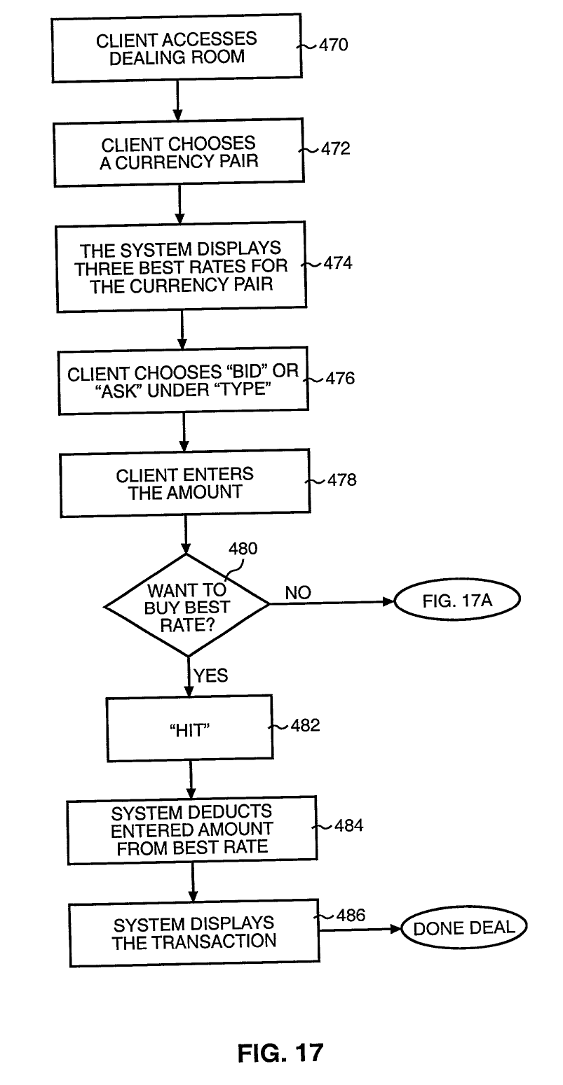

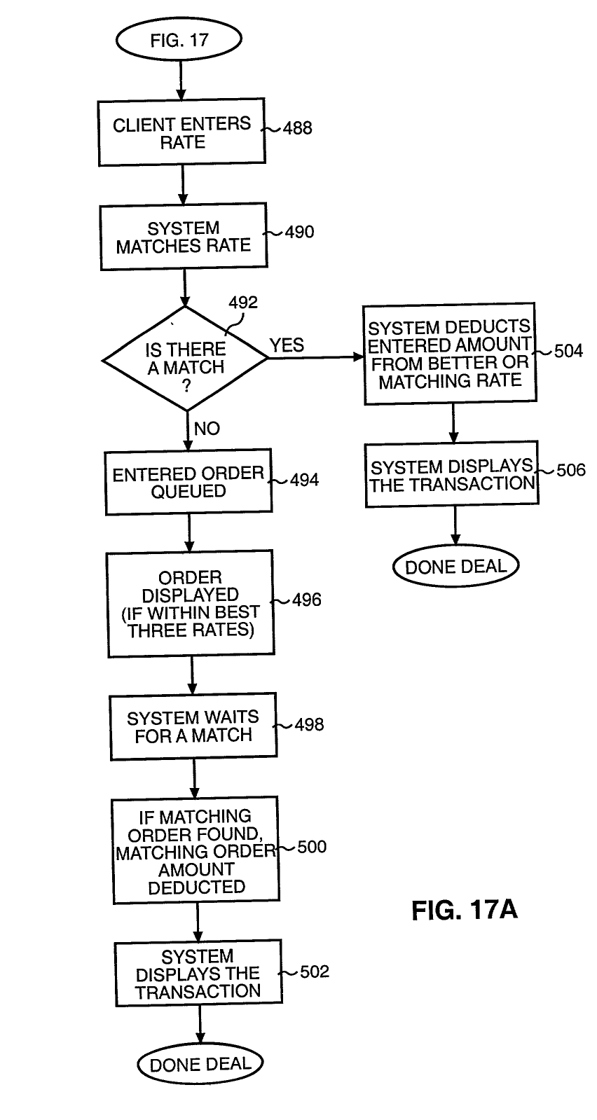

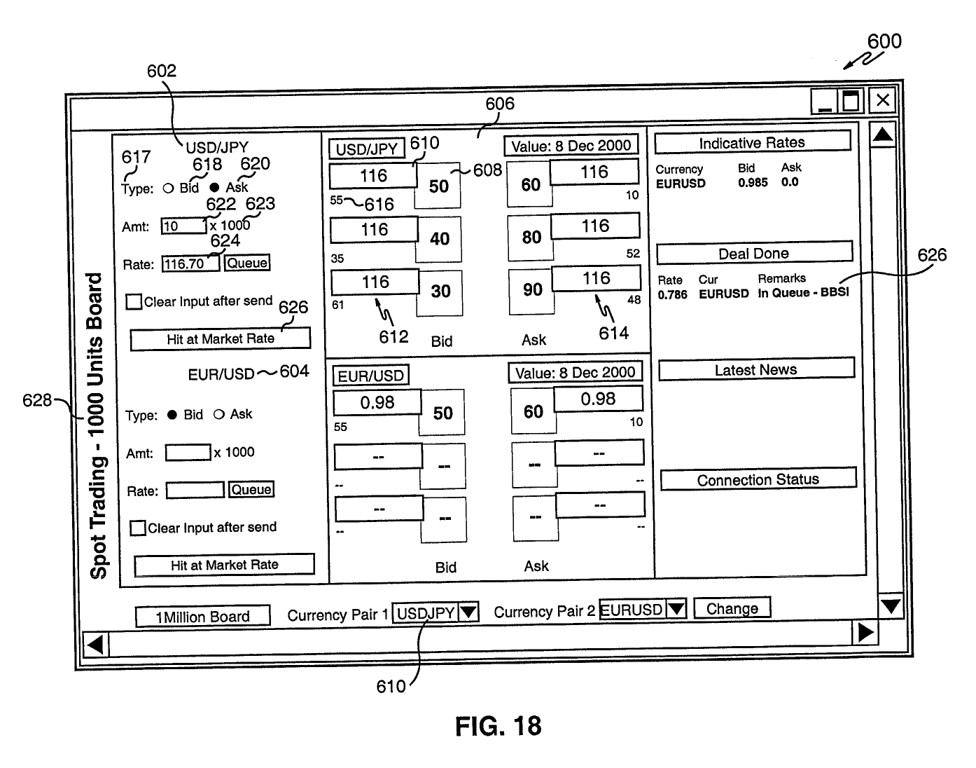

Once a proper login ID and a password are obtained, the client is able to trade currencies online using the dealing room Web interface 600 shown in FIG. 18. The details of how a client conducts a trade of currencies using the present system in step 452 shall be explained in reference to the flow diagram shown in FIGS. 17, 17A and 18. Referring now to FIG. 17, in step 470 the client accesses the dealing room as represented by the Web interface 600 shown in FIG. 18. The client then, in step 472, chooses a currency pair from the drop-down menu 610. Note that the interface 600 can show up to two currency pairs, in this case, US dollar against the Japanese Yen (USD/JPY) 602 and European Euro against the US dollar (EUR/USD) 604. For the purposes of describing the trading process, however, only the USD/JPY will be used as an illustrative example since the same steps will apply to all currency pairs.

In step 474, the system displays the best three rates for each currency pair. The rates posted are from all of those clients who are currently using the dealing room interface 600. Here, the best three rates for the USD/JPY are listed on the display board 606. Note that the last two digits of the exchange rate are shown in the larger box 608 in bold and the remaining digits are shown in the smaller box 610. The rates on the left side 612 indicate a rate at which the US dollar is being offered to be bought, and therefore the rate most favoring the US dollar will be considered the “best” rate from the viewpoint of the client looking at the display board 606. The best rate from the viewpoint of the client is listed first. The rates on the right side 614 indicate a rate at which the US dollar is being offered to be sold, and therefore the rate least favoring the US dollar will be considered the “best” rate from viewpoint of the client, and will be listed first The number 616 immediately below the smaller box 610 indicates the number of units of the currency being offered at the rate shown without the multiplier. The multiplier factor 628 is indicated on the left side of the interface. Although here the multiplier is 1000, other multipliers, e.g., 10,000, are clearly possible. Thus here, the number “55” indicates 55×1000 or US$55,000. It should be noted that the amount 55 need not have been placed by a single client. Where several clients place an order for the same rate, the amount is aggregated. Hence the amount 55 may have come from a single client, or it may be an aggregation of several orders placed by plurality of clients. The interface, 600, however does not indicate whether the posted amount comes from a single client or is an aggregation of multiple postings.

In step 476, the client chooses either a “Bid” 618 or “Ask” 620 under “Type” 617. Choosing “Bid” would indicate that the client wishes to buy US dollar against the Japanese Yen; choosing “Ask” would indicate that the client wishes to sell US dollar against Japanese Yen. In this case, for illustrative purposes only, “Ask” is selected which indicates that the client wishes to buy US dollars against the Japanese Yen. In step 478, the client enters the amount in the amount field 622 that the client wishes to sell or buy. Note that the multiplier 623 is 1000, so an entry of 10, for instance, is equaled to 10,000 units of currency, and in this case, US dollars.

In step 480, the client decides whether to buy or sell at the “best” rate posted on the display board 606. If yes, the client chooses “Hit at Market Rate” 626, step 482, and the system automatically assumes that the client wishes to trade on the best rate displayed on the display board 606. If the client has chosen “Bid”, then the “best” rate would be the first rate listed on the right side (“Ask” or “sell” side) of the display board 606. But if the client has chosen “Ask”, then the “best” rate would be the first rate listed on the left side (“Bid” or “buy” side) of the display board 606. The amount entered in amount field 622 will then be deducted from the amount 616 shown for the best rate in step 484. Here, because “Ask” was chosen under “Type”, the entered amount “10” will be deducted from the amount “55” 616. If the amount 55 is an aggregation of orders placed by several clients, the amount 10 will be deducted first from the “Bid” order which was placed first in time. So for instance, if a Client A placed an order for 8 units first and a Client B placed an order for 47 (hence a total of 55) second, then the 8 of the entered amount 10 will be deducted first from Client A's order of 8, and then the remaining 2 units will be deducted from Client B's order of 47. The amount remaining after the deduction, 45, will now be displayed. In the event that the entered amount is larger than what is available on display board, then all of the available amount is deducted from the posting and the remaining amount is posted. Once the deduction is made, the transaction is considered a “done deal” and the system displays the transaction in the “Deal Done” section 626. It should be noted that this section only shows the transactions performed by the current client; it does not list all of the transactions performed using the system.

Now referring to FIG. 17A, if in step 480 of FIG. 17 the client decides not to take the best rate, then the client enters the desired rate in the rate field 624 in step 488. In step 490, the system tries to match the rate against posted rates. In this case, the entered rate was 116.70 and the transaction is “Ask” (sell). Therefore, the system looks to the postings on the “Bid” side 612 of the display board 606 to see if there are any buyers who has posted a bid rate which either matches that entered by the client or is better. Since there is no buyer who is willing to buy US dollars at the rate entered by the client, the answer to the question in step 492 is “No”, and the system moves to step 494. If, on the other hand, the system determines that there is a match in step 492, then the system deducts the entered amount from the posted rate which either matches or surpasses the entered rate in step 504, and displays the transaction in step 506 under section entitled “Deal Done” 626.

In step 494, the entered order is queued among other orders. If the order entered is within the three best rates, it is posted on the display board 606 in step 496. The system then waits for a matching order to be placed by clients of other business entities who are using the system in step 498. If a matching order is found, then the system deducts the amount from the posted amount in step 500, and displays the transaction in step 502.

The settlement process of step 454 is performed by the system per the method defined by the administrator. In the preferred embodiment, the settlement process is performed by the business entity off-line using the existing settlement processes.

The present invention may be embodied in other specific forms without departing from the spirit or essential characteristics thereof. The presently disclosed embodiments are, therefore, to be considered in all respects as illustrative and not restrictive, the scope of the invention being indicated by the appended claims and all changes which come within the meaning and range of equivalency of the claims are, therefore, to be embraced therein.

We claim:

1. A method facilitated by a computer network to accomplish a foreign currency exchange transaction between business entities, comprising the acts of:
providing a central server system having a communication channel for electronically communicating with the business entities, whereby a representative of a first business entity that is registered is allowed access to the central server system;
allowing the representative to select a currency pair to be transacted;
displaying at least one rate for the selected currency pair posted by a representative from a second business entity which is registered with the central server system, the second business entity having established a mutual credit line with the first business entity; and
allowing the representative of the first business entity to place an order on the currency pair, whereby the order is matched against the posted rates, a match resulting in a trade, and a non-match resulting in a posting of the order.

2. The method as recited in claim 1 wherein particulars of the trade are shown on a display.

3. The method as recited in claim 1 wherein the central server system allows a business entity to limit an amount which can be traded by a representative.

4. The method as recited in claim 1 wherein the central server system allows a business entity to specify a period of time allowed for trading.

5. The method as recited in claim 1 wherein the central server system prevents a trading from occurring if a trade would exceed a pre-defined percentage of a credit line given to a business entity.

6. The method as recited in claim 5 wherein the central server system allows a business entity to determine the pre-defined percentage.

7. The method as recited in claim 1 wherein three best rates for a given currency pair are posted.

8. The method as recited in claim 1 wherein an amount of currency is posted with the rate.

9. The method as recited in claim 7 wherein an amount of currency is posted with the rates.

10. The method as recited in claim 8 wherein the amount can be an aggregation from a plurality of orders.

11. The method as recited in claim 9 wherein the amount can be an aggregation from a plurality of orders.

12. The method as recited in claim 8 wherein the amount is updated when a matching order is found.

13. The method as recited in claim 9 wherein the amount is updated when a matching order is found.

14. The method as recited in claim 10 wherein the amount is updated when a matching order is found.

15. The method as recited in claim 11 wherein the amount is updated when a matching order is found.

16. The method as recited in claim 1 wherein the central server system allows a business entity to directly send via the communication channel a foreign exchange order for a client.

17. The method as recited in claim 16 wherein the client is allowed to place the foreign exchange order through a network.

18. The method as recited in claim 17 wherein the client can place the order using an order entry interface accessed through a network.

19. The method as recited in claim 18 wherein the order entry interface is provided by a business entity's system.

20. The method as recited in claim 18 wherein the interface includes a field for order type.

21. The method as recited in claim 19 where the business entity's system allows a viewing of the order placed by the client through a order monitor.

22. The method as recited in claim 21 wherein the order placed by the client can be executed by the business entity servicing the client.

23. The method as recited in claim 16 wherein the client places a collateral with the business entity.

24. The method as recited in claim 17 wherein the client places a collateral with the business entity.

25. The method as recited in claim 23 wherein the business entity sets a limit on an amount the client can trade based on the amount of the collateral placed.

26. The method as recited in claim 24 wherein the business entity sets a limit on an amount the client can trade based on the amount of the collateral placed.

27. A method facilitated by a computer network to accomplish a foreign currency exchange transaction between business entities, comprising the acts of:
providing a central server system having a communication channel for electronically communicating with the business entities;
registering a first business entity whereby a representative is assigned a role of administrator, credit officer, and a trader, each role requiring a proper login ID and a password to access the central server system;
allowing the trader to select a currency pair to be transacted;
displaying at least one rate for the selected currency pair posted by a trader from a second business entity which is registered with the central server system, the second business entity having established a mutual credit line with the first business entity; and
allowing the trader of the first business entity to place an order on the currency pair, whereby the order is matched against the posted rates, a match resulting in a fulfillment of the order, and a non-match resulting in a posting of the order.

28. The method as recited in claim 27 wherein the trade is shown on a display.

29. The method as recited in claim 27 wherein the central server system allows the administrator to limit an amount which can be traded by the trader.

30. The method as recited in claim 27 wherein the central server system allows a business entity to specify a period of time allowed for trading.

31. The method as recited in claim 27 wherein the central server system prevents a trading from occurring if a trade would exceed a pre-defined percentage of a credit line given to a business entity.

32. The method as recited in claim 31 wherein the central server system allows the credit officer to determine the pre-defined percentage.

33. The method as recited in claim 27 wherein three best rates for a given currency pair are posted.

34. The method as recited in claim 27 wherein an amount of currency is posted with the rate.

35. The method as recited in claim 33 wherein an amount of currency is posted with the rates.

36. The method as recited in claim 34 wherein the amount can be an aggregation from a plurality of orders.

37. The method as recited in claim 35 wherein the amount can be an aggregation from a plurality of orders.

38. The method as recited in claim 34 wherein the amount is updated when a matching order is found.

39. The method as recited in claim 35 wherein the amount is updated when a matching order is found.

40. The method as recited in claim 36 wherein the amount is updated when a matching order is found.

41. The method as recited in claim 37 wherein the amount is updated when a matching order is found.

42. The method as recited in claim 27 wherein the central server system allows a business entity to directly send via the communication channel a foreign exchange order for a client.

43. The method as recited in claim 42 wherein the client is allowed to place the foreign exchange order through a network.

44. The method as recited in claim 43 wherein the client can place the order using an order entry interface accessed through a network.

45. The method as recited in claim 44 wherein the order entry interface is provided by a business entity's system.

46. The method as recited in claim 44 wherein the interface includes a field for order type.

47. The method as recited in claim 45 where the business entity's system allows a viewing of the order placed by the client through a order monitor.

48. The method as recited in claim 47 wherein the order placed by the client can be executed by the business entity servicing the client.

49. The method as recited in claim 42 wherein the client places a collateral with the business entity.

50. The method as recited in claim 43 wherein the client places a collateral with the business entity.

51. The method as recited in claim 49 wherein the business entity sets a limit on an amount the client can trade based on the amount of the collateral placed.

52. The method as recited in claim 50 wherein the business entity sets a limit on an amount the client can trade based on the amount of the collateral placed.

53. A method facilitated by a computer network to accomplish a foreign currency exchange transaction between clients having an account with a business entity, comprising the acts of:
providing a business entity's system having a communication channel for electronically communicating with the clients;
registering the clients with the business entity's system whereby the registered clients are allowed access to the business entity's system and whereby the registered clients place a collateral with the business entity;
allowing the clients to select a currency pair to be transacted;
displaying at least one rate for the selected currency pair posted by a registered client;
allowing the registered clients to place an order on the currency pair, whereby the order is matched against the posted rates, a match resulting in a trade, and a non-match resulting in a posting of the order;
and settling the trade.

54. The method as recited in claim 53 wherein particulars of the trade are shown on a display.

55. The method as recited in claim 53 wherein the business entity's system limits an amount which can be traded by a client, the limit being determined by an amount of collateral placed by the client.

56. The method as recited in claim 53 wherein three best rates for a given currency pair are posted.

57. The method as recited in claim 53 wherein an amount of currency is posted with the rate.

58. The method as recited in claim 56 wherein an amount of currency is posted with the rates.

59. The method as recited in claim 57 wherein the amount can be an aggregation from a plurality of orders.

60. The method as recited in claim 58 wherein the amount can be an aggregation from a plurality of orders.

61. The method as recited in claim 57 wherein the amount is updated when a matching order is found.

62. The method as recited in claim 58 wherein the amount is updated when a matching order is found.

63. The method as recited in claim 59 wherein the amount is updated when a matching order is found.

64. The method as recited in claim 60 wherein the amount is updated when a matching order is found.

65. The method as recited in claim 53 wherein the business entity is a bank.

66. The method as recited in claim 65 wherein the clients are account holders of the bank.
